(19) United States
(12) Patent Application Publication
(10) Pub. No.: US 2020/0195520 A1
(43) Pub. Date: Jun. 18, 2020

(54) ADAPTIVE FUNCTION EXECUTION IN A FUNCTION AS A SERVICE (FAAS) ARCHITECTURE

(71) Applicant: Intel Corporation, Santa Clara, CA (US)

(72) Inventors: Francesc GUIM BERNAT, Barcelona (ES); Durgesh SRIVASTAVA, Cupertino, CA (US); Alexander BACHMUTSKY, Sunnyvale, CA (US); Ramanathan SETHURAMAN, Bangalore (IN); Harald SERVAT, Barcelona (ES)

(21) Appl. No.: 16/395,790

(22) Filed: Apr. 26, 2019

Related U.S. Application Data
(60) Provisional application No. 62/779,752, filed on Dec. 14, 2018.

(51) Int. Cl. H04L 12/24; H04L 12/851; G06F 17/50

(52) U.S. Cl. CPC H04L 41/5012; G06F 17/5054; H04L 47/2425; H04L 47/2408

(57) ABSTRACT

A function as a service (FAAS) computing system includes processing to adaptively select function flavors to implement requested functions. Processing includes receiving a request to perform a function from an application, discovering one or more flavors for the function, each flavor to implement the function on computing hardware components of computing platforms, and selecting a first function flavor to implement the requested function. Processing further includes causing execution of the first function flavor by a first computing hardware component for the requested function, determining whether performance degradation of the first computing hardware component exists for the first function flavor, and if so, selecting a second function flavor to implement the requested function, and causing execution of the second function flavor by a second computing hardware component for the requested function, and if not, continuing to cause execution of the first function flavor for requests for the function.

### CROSS-REFERENCE TO RELATED APPLICATION

This application claims the benefit of U.S. Provisional Application No. 62/779,752, filed Dec. 14, 2018.

A portion of the disclosure of this patent document contains material which is subject to copyright protection. The copyright owner has no objection to the facsimile reproduction by anyone of the patent document or the patent disclosure, as it appears in the Patent and Trademark Office patent file or records, but otherwise reserves all copyright rights whatsoever. The copyright notice applies to all data as described below, and in the accompanying drawings hereto, as well as to any software described below: Copyright © 2019, Intel Corporation, All Rights Reserved.

### TECHNICAL FIELD

Examples described herein are generally related to techniques used by a cloud computing architecture.

### BACKGROUND

Video analytics and other types of function-oriented computing workloads have become one of the more relevant building blocks of many new workloads used in multiple computing domains. For example, hospitals analyze X-ray or computerized tomography (CT) scan images to speed up patient diagnosis, while labs can analyze microscopy images to accelerate new drug discovery efforts. In smart cities, object tracking for cars can help improve traffic flows. In the online environment, faces and objects are susceptible to being recognized and classified in each of the hundreds of millions of photos and videos that are uploaded to social networking applications every day. Airports and airlines can use facial recognition to speed up check-in and boarding processes, while governments use facial recognition to aid border control agents in processing passports.

It may be desirable to provide a computing environment where implementation of such functions can be distributed across components in a scalable and flexible cloud computing architecture.

### BRIEF DESCRIPTION OF THE DRAWINGS

FIG. 1 illustrates an example cloud computing architecture according to some embodiments.

FIG. 2 illustrates an example first computing system according to some embodiments.

FIG. 3 is a flow diagram of adaptive function execution according to some embodiments.

FIG. 4 is a diagram of adaptive function execution processing according to some embodiments.

FIG. 5 illustrates an example second computing system according to some embodiments.

### DETAILED DESCRIPTION

As contemplated in the present disclosure, embodiments of the present invention comprise a cloud computing architecture to provide Function as a Service (FaaS) capabilities and accelerated FAAS capabilities (AFaaS). FaaS is one of the potential solutions for both edge and cloud deployments in order to provide scalable and flexible computing for clients. AFaaS includes FaaS functions that run on accelerated, special purpose computing hardware instead of general-purpose computing hardware. The FaaS paradigm provides for deployment of services using different types of function implementations seamlessly and independently of the underlying computing hardware and system complexities. One benefit of FaaS is that FaaS allows services to be moved to different locations in a computing environment and to utilize different types of function implementations regardless of the service implementation. For example, in a system with a surveillance service calling a function to perform person detection processing, the FaaS computing architecture may execute the function's implementation on an accelerated special-purpose hardware or on a general-purpose processor depending on the available resources.

There are at least two challenges for successfully implementing distributed FaaS computing architectures. First, there may be a lack of centralized entities that control how each of the FaaS target function implementations are operating and their corresponding capacity to process more function calls. Even if centralized entities are performing such control, the level of granularity is so small (e.g., on the order of milliseconds (ms) or even microseconds) that a centralized entity may not be able to perform sufficient monitoring and enforcement of function operations. Second, the dynamic nature of such systems makes the lack of control issue even more complex. It can be very complicated to address processing load distribution and service level agreements (SLAs) for cloud computing systems when services and functions may change drastically from one timestamp to the next.

Embodiments of the present invention comprise an adaptive apparatus where FaaS clients (abstracted and implemented in a network interface controller (NIC) in one example) are responsible to select an appropriate implementation for a given function as a service and adaptively use this implementation as the response time of that implementation changes over time (e.g., due to higher congestion). Embodiments of the present invention target computing architectures where functions are implemented in multiple ways and also to disaggregated server architectures.

In embodiments, there are multiple FaaS function implementations (also called flavors herein) available to system tenants (e.g., clients) for a given service being provided. The multiple FaaS function implementations can be performed by different combinations of hardware and software in the FaaS computing architecture, depending on multiple factors (such as available hardware, Quality of Service (QoS) requirements, cost, etc.). Embodiments dynamically and adaptively select which flavor to be used for a requested function.

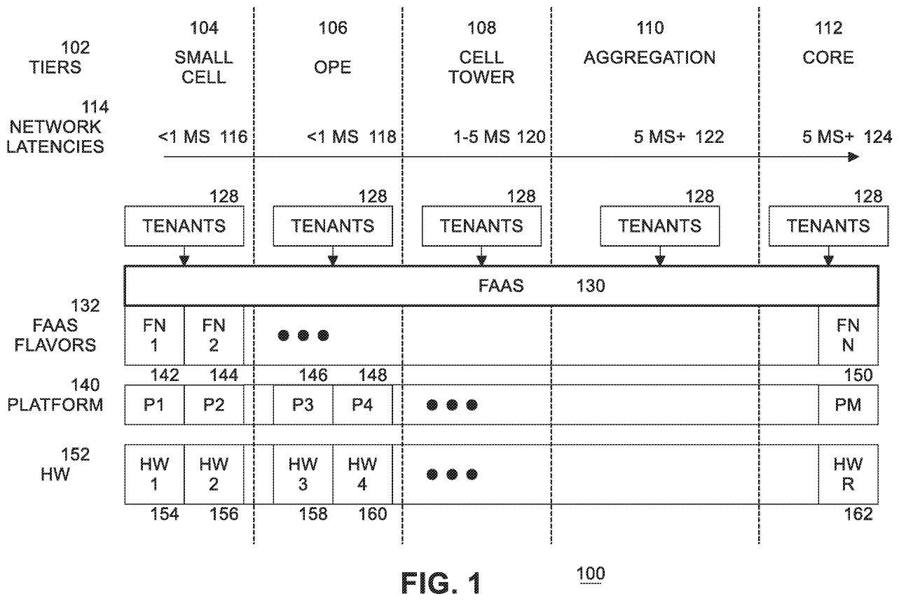

FIG. 1 illustrates an example cloud computing architecture 100 showing how FaaS may be distributed across a computing environment. There may be multiple tiers 102 of computing devices, each with particular processing capabilities and associated network latencies 114. For example, in cloud computing architecture 100 there is a tier 104 including one or more “small cell” computing devices with a network latency 116 less than approximately 1 millisecond (ms), a tier 106 including one or more on-premise equipment (OPE) computing devices with a network latency 118 less than approximately 1 ms, a tier 108 including one or more cell tower computing devices with a network latency of approximately 1 to 5 ms, a tier 110 including one or more aggregation computing devices with a network latency of approximately 5 ms or more, and a tier 112 including one or more core computing devices with a network latency of approximately 5 ms or more.

A computing device in a tier is operable to process data for one or more tenants 128 (e.g., clients, users or customers). Tenant 128 comprises a computing device operated by a client, user, or customer. For example, a tenant computing device may be a smartphone, a laptop computer, a tablet computer, an autonomous vehicle or aircraft, or any other computing device operated by a tenant. Tenants 128 are coupled with one or more tiers to communicate requests for a function to be performed by cloud computing architecture 100 and to receive responses to those requests.

In an embodiment, tenants 128 request functions to be performed by FaaS 130. FaaS 130 is executed by any one or more of the computing devices in the tiers. That is, performance of the requested function may be implemented by any one or more of computing devices in any one or more tiers. In an embodiment, an instance of FaaS 130 is executed by all computing devices in cloud computing architecture 100. FaaS 130 provides a plurality of FaaS flavors 132. For example, FaaS flavors 132 includes FaaS flavor FN1 134, FaaS flavor FN2 136, . . . FaaS flavor FN N 138, where N is a natural number. A function comprises any data processing operation. As used herein, a FaaS flavor is a particular implementation of a function provided to tenants in a cloud computing architecture such as computing system 100. In embodiments, a FaaS flavor is implemented in computing system 100 in a computing platform 140. A cloud computing architecture such as computing system 100 provides a plurality of computing platforms 140 (e.g., computer servers), with each computing platform providing a set of computing hardware and software capabilities. For example, computing system 100 includes a plurality of computing platforms such as computing platform P1 142, computing platform P2 144, computing platform P3 146, computing platform P4 148, . . . computing platform PM 150, where M is a natural number. Underlying each computing platform 140 is particular computing hardware components 152 (e.g., “bare metal”). Computing hardware 152 may be implemented as a general-purpose computer system, a field programmable gate array (FPGA) (e.g., for AFaaS functions), an application specific integrated circuit (ASIC) (e.g., for AFaaS functions), or any combination of the above. For example, computing hardware 152 includes hardware 1 154, hardware 2 156, hardware 3 158, hardware 4 160, . . . hardware R 162, where R is a natural number. In some embodiments, multiple FaaS flavors 132 are implemented on a single computing platform 140. In some embodiments, multiple computing platforms are implemented on a single computing hardware 152. In some embodiments, a single FaaS flavor 132 is implemented on a single computing platform 140. In some embodiments, a single computing platform 140 is implemented on a single computing hardware 152.

In some embodiments, a tenant 128 requesting a FaaS function to be performed by a cloud computing architecture such as computing system 100 does not know which FaaS flavor 132 implements the requested FaaS function by the tenant, which computing platform 140 implements the selected FaaS flavor 132, and/or which computing hardware 152 implements the selected computing platform 140. The tenant simply requests the FaaS function to be performed by FaaS 130, FaaS 130 determines where to perform the function, selects a flavor for the requested function, causes the function to be performed on some compute node within the cloud computing architecture such as computing system 100, and FaaS 130 returns the results back to the tenant. In some embodiments, tiers 102, computing platforms 140, and computing hardware 152 are geographically dispersed and communicate with each other over known computing networking technologies (e.g., WiFi, cellular telephone networks, the Internet, the “cloud”, etc.). In some embodiments, FaaS 130 uses the network latencies 114 of the tiers 102 and characteristics (including current performance measurements) of computing platforms 140 and computing hardware 152 in determining which FaaS flavor in computing system 100 is selected for a given tenant's function request.

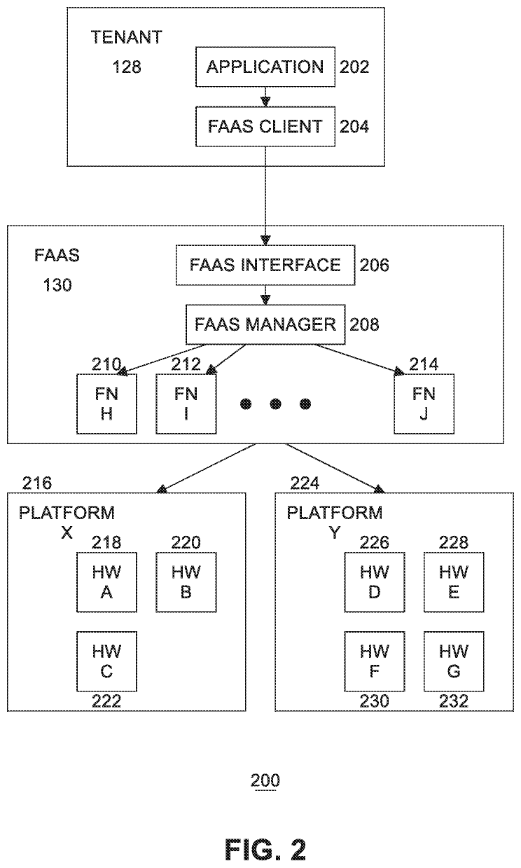

FIG. 2 illustrates a first computing system 200 according to some embodiments. A tenant 128 includes an application program 202, which provides any data processing capabilities of interest to the tenant. As part of that data processing, application 202 may need to have one or more functions performed by FaaS 130 (e.g., application 202 wants to shift computation of the function from the tenant computing device to somewhere else in the cloud computing architecture. For example, if tenant 128 does not have enough computing power to perform the needed function, performance of the function can be performed somewhere else in the cloud computing architecture. Application 202 calls FaaS client 204 in tenant 128 requesting performance of a selected function. FaaS client is communicatively coupled with FaaS interface 206 in FaaS 130. FaaS client 204 forwards the function request to FaaS interface 206 in FaaS 130. FaaS interface 206 forwards the function request to FaaS manager 208. In some embodiments, FaaS interface 206 and FaaS manager 208 are integrated into one component.

FaaS manager 208 selects a FaaS flavor 132 such as one of FN H 210, FN I 212, . . . FN J 214 to implement the function requested by the tenant based at least in part on tenant and/or function requirements, and current operating performance measurements the computing system 200. Examples of current operating performance measurements or metrics include frames per second, amount of megabytes per second processed for voice recognition, and so on. FaaS 130 determines for each FaaS flavor which computing platform 140 and computing hardware 152 (also called a FaaS target, collectively) to use to execute the selected FaaS flavor. For example, FaaS function FN H 210 could be executed by HW A 218, HW B 220, or HW C 222 of computing platform X 216, or by HW D 226, HW E 228, HW F 230, or HW G 232 of computing platform Y 224. Similarly, FaaS FN I 212, . . . FN J 214 could be executed by any of the computer hardware components of platform X 216 or platform Y 224.

In some embodiments, the mapping of a FaaS flavor 132 to a computing platform 140 is static and predetermined. In some embodiments, the mapping of a FaaS flavor 132 to a computing platform 140 is dynamic and changed depending on conditions in the cloud computing architecture. In some embodiments, the mapping of a computing platform 140 to computing hardware 152 is static and predetermined. In some embodiments, the mapping of a computing platform 140 to computing hardware 152 is dynamic and changed depending on conditions in the cloud computing architecture.

In some embodiments, FaaS client 204 uses FaaS Manager 208 to discover what function implementations (e.g., flavors) available are for FaaS 130. To do so, FaaS client 204 uses the requirements provided by FaaS 130 or by application 202. In an embodiment, FaaS functions may be described in terms of one or more service input parameters such as performance, cost, and service density, etc.

Once FaaS 130 is deployed and fully utilizing a given FaaS function implementation (seamlessly to the service), FaaS client 204 is responsible for monitoring that the service input parameters are continually satisfied by the FaaS function implementation. When this is no longer true, in an embodiment FaaS 204 client uses an adaptive and dynamic process as described herein to select another FaaS function flavor (which may be compute intensive with respect to the three parameters).

One challenge for implementing a highly dynamic FaaS 130 in a cloud computing architecture is how to detect that a particular FaaS function flavor is no longer capable of achieving performance targets from the tenant perspective and to select a new FaaS function flavor. Additionally, FaaS 130 must decide whether and when to return to executing the FaaS function flavor that was originally selected.

One aspect of embodiments of the present invention is that an adaptive process is used to speculatively test when the most appropriate FaaS function flavor can satisfy the performance requirements or not. To do this FaaS client 204 uses variable time distances between each test depending on past experience. This reduces the computing demands on the target FaaS function flavor while there is still a high computational workload.

Embodiments of the present invention provide improved scalability because of inherent decentralization and provide adaptive behavior that is capable of using alternative solutions (e.g., utilizing cost and performance trade-offs) when the best FaaS function flavor cannot provide the level of performance required by application 202 while not using service level agreement (SLA) interfaces.

One challenge of a cloud computing architecture such as computing system 100 is in situations where an accelerator or another form of computing resource provided access by FaaS 130 starts approaches saturation (e.g., maximum processing throughput), resulting in increasing latencies (e.g., performance degradation). As a computing resource crosses this point the latencies are expected to grow exponentially. Hence, there is a need to expand previous approaches in order to detect when those situations happen and allow FaaS manager 208 to decide what FaaS function flavor to utilize. A given FaaS function (e.g., face detection, traffic detection, and so on) may have multiple implementations (e.g., flavors) in cloud computing architecture 100. Some of these function implementations may be local (e.g., they are meant to be executed locally in a processor or in accelerators attached to the processor) and some of them may be remote. Each of these functions is characterized by several parameters such as performance, cost, and service density. The performance parameter includes how fast an accelerator can perform that particular function (therefore contributing to network latency) and how much bandwidth is used. The cost parameter includes how expensive it is to execute such a function. In an embodiment, the function cost may be derived from the cost of the computing hardware itself to power the cost of the computing resource. Choosing to execute a particular function implementation that corresponds to a local processor instead of a remote accelerator may imply that processing cores from a local computing platform cannot be used by other services that may not have the option to use accelerated FaaS.

One challenge for highly dynamic architectures is how to detect that a particular FaaS function flavor is no longer appropriate for achieving performance targets from the tenant perspective and how to select a new FaaS function flavor. Further, how to decide whether to and when to return to execute the FaaS function flavor that was originally selected should be included.

FaaS client 204 can use FaaS manager 208 to discover the FaaS function flavors available for FaaS 130. To do so, FaaS manager 208 uses the requirements provided by FaaS 130 or by application 202. As already discussed, the parameters may be described in terms of performance, cost and service density. Once a selected FaaS function flavor is deployed on a FaaS target, FaaS manager 208 monitors that the three service input values are continually satisfied by FaaS 130. When this is no longer true, FaaS manager 208 uses the process described below in order to temporarily select another FaaS function flavor.

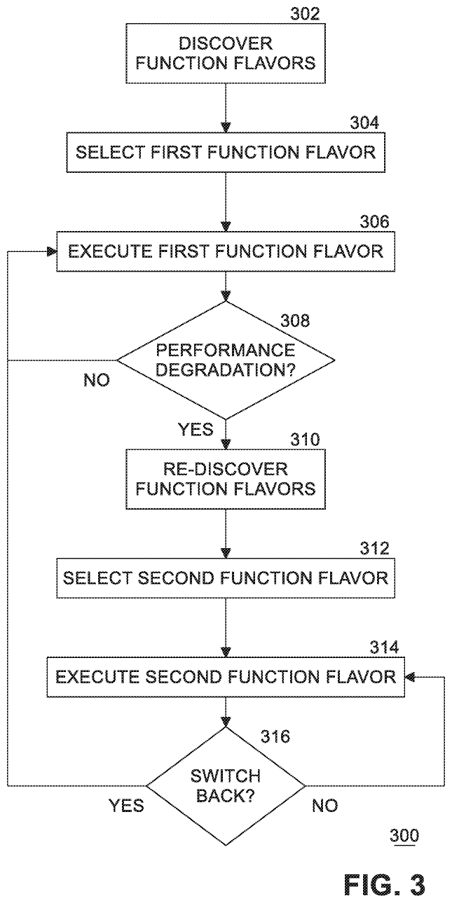

FIG. 3 is a flow diagram 300 of adaptive function execution according to some embodiments. FAAS 130 receives a request to perform a function from a tenant's application. At block 302, FaaS manager 208 discovers available (e.g., supported) FaaS function flavors provided by FaaS 130 to application 202 of tenant 128. At block 304, FaaS manager 208 selects a first FaaS function flavor to perform a function requested by application 202. At block 306, FaaS 130 executes the first function flavor on a FaaS target, using a selected computing platform 140 and associated computing hardware component 152 for the first function flavor. At block 308, performance of the first FaaS function flavor is checked and if there is no performance degradation then FaaS 130 continues executing the first FaaS function flavor at block 306. In some embodiments, FaaS 130 continually monitors performance of FaaS functions by computing platforms 140. However, if there is a performance degradation above a determined or selected threshold (e.g., one or more of computing hardware components 152 is not performing requested functions at an acceptable level), then at block 310 FaaS manager 208 re-discovers FaaS function flavors that are currently available on FaaS 130. Re-discovery is needed because the set of available FaaS function flavors in FaaS 130 may have changed since the first FaaS function flavor was selected by FaaS manager 208. At block 312, FaaS manager 208 selects a second FaaS function flavor (to replace the first FaaS function flavor). At block 314, FaaS 130 executes the second FaaS function flavor (on a FaaS target which may be different than the FaaS target used for the first FaaS function flavor). At block 316, at some point in the future, a decision is made by the FaaS manager whether to switch from the second FaaS function flavor back to the first FaaS function flavor. In an embodiment, the decision is made by FaaS manager 208 based at least in part on current operating conditions of FaaS 130 (including SLA network latency and computational cost), computing platforms 140, and computing hardware 152. In an embodiment, FaaS manager 208 determines that the first FaaS function flavor's performance is back to normal (e.g., no performance degradation). If no switch is decided, then FaaS 130 continues executing the second FaaS function flavor at block 314. If a switch is decided, processing continues with executing the first FaaS function flavor at block 306.

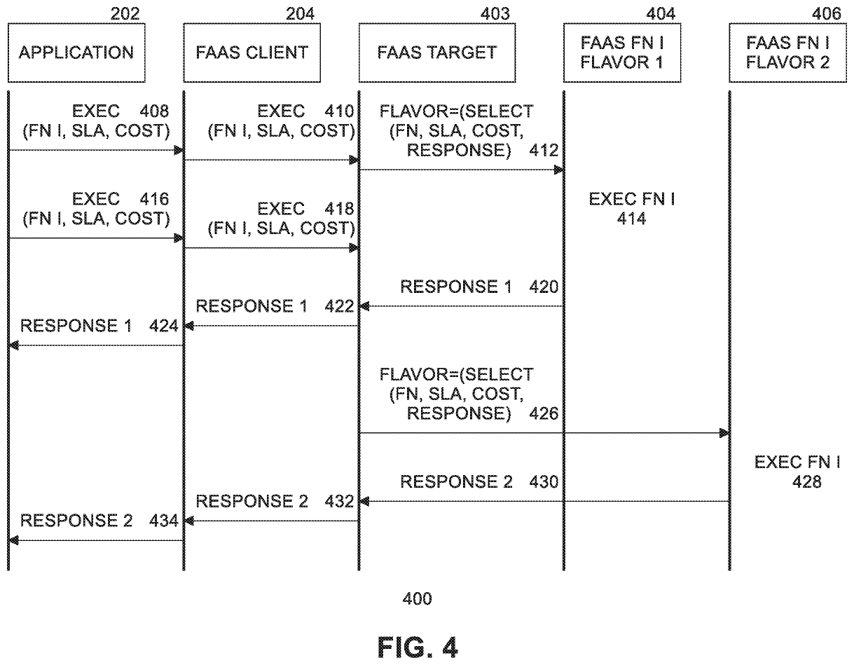

FIG. 4 is a diagram of adaptive function execution processing according to some embodiments. Tenant's application 202 requests execution of a function, such as function I (FN I) 212, represented herein as control flow 408. A function execution request may include a function name or identifier (e.g., FN I 212), an SLA name or indicator (for example, a network latency requirement to perform the function in less than 10 ms), and a cost (for example, a requirement to perform the function using less than 10 computation units of computing system 100). Other parameters may also be used. Application 202 sends the function request 408 to FAAS client 204. FAAS client 204 passes the function request as control flow 410 to FAAS target 403 over FAAS interface 206 in FAAS 130. FAAS target 403 selects an FAAS flavor to implement the function request. In some embodiments, FAAS target uses the requested function name/ID, SLA network latency requirement, and cost requirement received from the tenant, and optionally current operating performance measurements to select the flavor. For example, FAAS FN I flavor 1 404 may be selected because FAAS FN I flavor 1 404 has an SLA network latency limit of 5 ms and a cost of 8 units. FAAS FN I flavor 1 404 meets the requirements of the function request (e.g., SLA network latency is 5 ms, meeting the requirement of less than 10 ms, and cost is 8 units, meeting the requirement of less than 10 ms). FAAS target 403 may also take current operating performance measurements into account when selecting the function flavor. FAAS FN I flavor 1 404 is implemented as one of HW A 218, HW B 220, HW C 222, HW D 226, HW E 228, HW F 230, or HW G 232 (e.g., executing on FaaS target 403). FAAS FN I flavor 1 404 executes FN I at 414. While FAAS FN I flavor 1 404 is executing the requested function, another request for the same function may be received by FAAS client 204 from application 202 (e.g., Exec (FN I, SLA, cost) 416). In this example, the new function request 416 has an SLA network latency requirement of <40 ms, and a cost requirement of <1 unit. FAAS client 204 forwards the request at flow 418 to FAAS target 403. In this example, when execution 414 of FN I is complete, a response 1 420 is sent by FAAS FN I flavor 1 404 back to FAAS target 403. The FAAS target forwards response 1 422 to FAAS client 204. FAAS client 204 returns response 1 424 back to the tenant's application 202.

FAAS target 403 selects an FAAS flavor to implement function request 426. FAAS target 403 determines that FAAS FN I flavor 1 404 is no longer appropriate to use because FAAS FN I flavor 1 404 cannot meet the SLA network latency requirement of function request 426 (e.g., possibly due to performance degradation of FAAS FN I flavor 1 404 on the selected computing hardware component). Therefore, FAAS target 403 selects FAAS FN I flavor 2 406 to implement function request 426, because FAAS FN I flavor 2 406 provides an SLA network latency limit of 35 ms and a cost of 0.5 units (in this example). FAAS target 403 may also take current operating performance measurements into account when selecting the function flavor. FAAS FN I flavor 2 406 executes 428 the requested function FN I 212. When execution is complete, FAAS FN I flavor 2 406 sends response 2 430 back to FAAS target 403. FAAS target 403 returns response 2 432 to FAAS client 204. FAAS client returns response 2 434 back to the tenant's application 202.

In this simple example, implementation of a function was assigned to FAAS FN I flavor 1 404 and then to FAAS FN I flavor 2 406 based at least in part on the SLA, cost, and optionally current operating performance measurements. In future, the function FN I 212 may be assigned back to FAAS FN I flavor 1 404 from FAAS FN I flavor 2 406 depending on current operating performance measurements. Although only two flavors are discussed in this example, in various embodiments the number of flavors, the number of functions, and the number of function requests supported per unit time are implementation dependent. In a complex cloud computing architecture such as computing system 100, embodiments of the present invention adaptively and dynamically select function flavors for any number of received function requests and associated functions, depending on the computational and network processing capabilities of platforms 140 and hardware 152 (e.g., FaaS targets). In some embodiments, computing system 100 may support millions of tenants making millions of function requests to FAAS 130. Dynamically and adaptively assigning functions to FAAS flavors allows computing system 100 to provide an optimal or near optimal system performance as conditions change due to tenant activity.

Included herein is a set of logic flows representative of example methodologies for performing novel aspects of the disclosed architecture. While, for purposes of simplicity of explanation, the one or more methodologies shown herein are shown and described as a series of acts, those skilled in the art will understand and appreciate that the methodologies are not limited by the order of acts. Some acts may, in accordance therewith, occur in a different order and/or concurrently with other acts from that shown and described herein. For example, those skilled in the art will understand and appreciate that a methodology could alternatively be represented as a series of interrelated states or events, such as in a state diagram. Moreover, not all acts illustrated in a methodology may be required for a novel implementation.

A logic flow may be implemented in software, firmware, and/or hardware. In software and firmware embodiments, a logic flow may be implemented by computer executable instructions stored on at least one non-transitory computer readable medium or machine readable medium, such as an optical, magnetic or semiconductor storage. The embodiments are not limited in this context.

An example of pseudocode implementing operations of adaptive function execution in a multi-implementation FaaS cloud computing architecture is shown below.

© 2018 Intel Corporation

FaaS Client Initialization (FaaSID)

BestCandidate=FaaSSelect (SLA= {Latency, BW}, OptCost, FaaSID);
LastTimeBestCandidateChecked=−1;
BestCandidateNoSuitable=false;
switch(threshold_type)
{

| | |
|---|---|
| case lineal: | For (i=0; i < num_thresolds; i++) NextDelayToCheck[i]=i; |

case quadratic: For (i=0; i < num_thresolds; i++) NextDelayToCheck[i]=i\hat{ }2;
case exponential: For (i=0; i < num_thresolds; i++) NextDelayToCheck[i]=2\hat{ }i;
}
SLA_vs_Cost_threshold=10%;

FaaS Client Runtime (FaaSID)

If (BestCandidateNotSuitable)
{

If (LastTimeBestCandidateChecked+NextDelayToCheck[current_threshold] >

CurrentTime)

{
#We evaluate if best candidate has improved

CurrentPerformance = ExecuteFaaS(BestCandidate, FaaSID, Payload);
{LastBestCandidateKnownLatency, LastBestCandidateKnownBW} =

CurrentPerformance;

If (Max((LastBestCandidateKnownLatency/SLA.Latency),

(LastBestCandidateKnownBW/SLA.BW))

/ (CurrentCandidate.cost/BestCandidate.coast))
> SLA_vs_Cost_threshold)

{

#Best Candidate still not good
BestCandidateNotSuitable= false;
current_threshold++;

```
  }
  else
  {
```

#Best Candidate now improved
BestCandidateNotSuitable= true;
current_threshold−−;

}

} else {

#Nothing to evaluate here - we use the alternative

CurrentCandidate = FaaSSelect (SLA = {Latency, BW}, OptCost, FaaSID,

WhiteList = BestCandidate);

ExecuteFaaS(CurrentCandidate, FaaSID, Payload);

}

} else {
{

#Currently best candidate is still good enough
CurrentPerformance = ExecuteFaaS(BestCandidate, FaaSID, Payload);
{LastBestCandidateKnownLatency, LastBestCandidateKnownBW} =

CurrentPerformance;

If (Max((LastBestCandidateKnownLatency/SLA.Latency),

(LastBestCandidateKnownBW/SLA.BW))

/ (CurrentCandidate.cost/BestCandidate.coast))
> SLA_vs_Cost_threshold)

{

```
  #Best candidate now not too good
  BestCandidateNotSuitable = false;
  current_threshold++;
```

} else {

#Best is still the best - decrease adaptive threshold

If (current_threshold > 0) current_threshold—

}

}

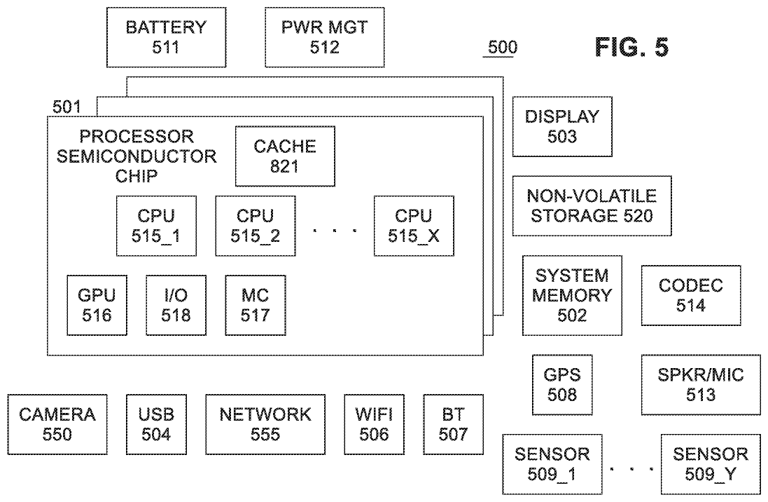

FIG. 5 illustrates an example second computing system. Second computing system 500 may be used to implement any of the logic and/or processing described in FIGS. 1-4, and the pseudocode shown above. According to some examples, computing system 500 may include, but is not limited to, an edge device, a small cell, on-premise equipment, a base station, a central office switching equipment, a cell tower computing device, a server, a server array or server farm, a web server, a network server, an Internet server, a work station, a mini-computer, a main frame computer, a supercomputer, a network appliance, a web appliance, a distributed computing system, a personal computer, a tablet computer, a smart phone, multiprocessor systems, processor-based systems, a smartphone, an aggregating server, a core server, or combination thereof.

In one example, computing system 500 is a disaggregated server. A disaggregated server is a server that breaks up components and resources into subsystems. Disaggregated servers can be adapted to changing storage or compute loads as needed without replacing or disrupting an entire server for an extended period of time. A server could, for example, be broken into modular compute, I/O, power and storage modules that can be shared among other nearby servers. In an embodiment, computing system 500 is an infotainment system resident in a vehicle (e.g., an automobile, a truck, a motorcycle, etc.), a ship, an aircraft, or a spacecraft.

As observed in FIG. 5, the computing system 500 may include at least one processor semiconductor chip 501. Computing system 500 may further include at least one system memory 502, a display 503 (e.g., touchscreen, flat-panel), a local wired point-to-point link (e.g., USB) interface 504, various network I/O functions 555 (such as an Ethernet interface and/or cellular modem subsystem), a wireless local area network (e.g., WiFi) interface 506, a wireless point-to-point link (e.g., Bluetooth (BT)) interface 507 and a Global Positioning System (GPS) interface 508, various sensors 509_1 through 509_Y, one or more cameras 550, a battery 511, a power management control unit (PWR MGT) 512, a speaker and microphone (SPKR/MIC) 513 and an audio coder/decoder (codec) 514. The power management control unit 512 generally controls the power consumption of the system 500.

An applications processor or multi-core processor 501 may include one or more general purpose processing cores 515 within processor semiconductor chip 501, one or more graphical processing units (GPUs) 516, a memory management function 517 (e.g., a memory controller (MC)) and an I/O control function 518. The general-purpose processing cores 515 execute the operating system and application software of the computing system. In an embodiment, cores 515 execute FAAS 130. The graphics processing unit 516 executes graphics intensive functions to, e.g., generate graphics information that is presented on the display 503. The memory control function 517 interfaces with the system memory 502 to write/read data to/from system memory 802.

Each of the touchscreen display 503, the communication interfaces 504, 555, 506, 507, the GPS interface 508, the sensors 509, the camera(s) 510, and the speaker/microphone codec 513, and codec 514 all can be viewed as various forms of I/O (input and/or output) relative to the overall computing system including, where appropriate, an integrated peripheral device as well (e.g., the one or more cameras 510). Depending on implementation, various ones of these I/O components may be integrated on the applications processor/multi-core processor 501 or may be located off the die or outside the package of the applications processor/multi-core processor 501. The computing system also includes non-volatile storage 520 which may be the mass storage component of the system.

Computing system 500 may also include components for communicating wirelessly with other devices over a cellular telephone communications network is as known in the art.

Various examples of computing system 500 when embodied as a small cell, on-premise equipment, base station, cell tower computing device, aggregation server, core server, or central office may omit some components discussed above for FIG. 5.

Various examples may be implemented using hardware elements, software elements, or a combination of both. In some examples, hardware elements may include devices, components, processors, microprocessors, circuits, circuit elements (e.g., transistors, resistors, capacitors, inductors, and so forth), integrated circuits, ASICs, PLDs, DSPs, FPGAs, memory units, logic gates, registers, semiconductor device, chips, microchips, chip sets, and so forth. In some examples, software elements may include software components, programs, applications, computer programs, application programs, system programs, operating system software, middleware, firmware, software modules, routines, subroutines, functions, methods, procedures, software interfaces, APIs, instruction sets, computing code, computer code, code segments, computer code segments, words, values, symbols, or any combination thereof. Determining whether an example is implemented using hardware elements and/or software elements may vary in accordance with any number of factors, such as desired computational rate, power levels, heat tolerances, processing cycle budget, input data rates, output data rates, memory resources, data bus speeds and other design or performance constraints, as desired for a given implementation.

Some examples may be described using the expression “in one example” or “an example” along with their derivatives. These terms mean that a particular feature, structure, or characteristic described in connection with the example is included in at least one example. The appearances of the phrase “in one example” in various places in the specification are not necessarily all referring to the same example.

Some examples may be described using the expression “coupled” and “connected” along with their derivatives. These terms are not necessarily intended as synonyms for each other. For example, descriptions using the terms “connected” and/or “coupled” may indicate that two or more elements are in direct physical or electrical contact with each other. The term “coupled,” however, may also mean that two or more elements are not in direct contact with each other, but yet still co-operate or interact with each other.

It is emphasized that the Abstract of the Disclosure is provided to comply with 37 C.F.R. Section 1.72(b), requiring an abstract that will allow the reader to quickly ascertain the nature of the technical disclosure. It is submitted with the understanding that it will not be used to interpret or limit the scope or meaning of the claims. In addition, in the foregoing Detailed Description, it can be seen that various features are grouped together in a single example for the purpose of streamlining the disclosure. This method of disclosure is not to be interpreted as reflecting an intention that the claimed examples require more features than are expressly recited in each claim. Rather, as the following claims reflect, inventive subject matter lies in less than all features of a single disclosed example. Thus, the following claims are hereby incorporated into the Detailed Description, with each claim standing on its own as a separate example. In the appended claims, the terms “including” and “in which” are used as the plain-English equivalents of the respective terms “comprising” and “wherein,” respectively. Moreover, the terms “first,” “second,” “third,” and so forth, are used merely as labels, and are not intended to impose numerical requirements on their objects.

Although the subject matter has been described in language specific to structural features and/or methodological acts, it is to be understood that the subject matter defined in the appended claims is not necessarily limited to the specific features or acts described above. Rather, the specific features and acts described above are disclosed as example forms of implementing the claims.

1. A function as a service (FAAS) computing system comprising:
a processing core; and
a memory coupled to the processing core, the memory having instructions stored thereon that, in response to execution by at least one of the processing core, cause the processing core to:
receive a request to perform a function from an application;
discover one or more flavors for the function, each flavor to implement the function on a selected one of a plurality of computing hardware components of a selected one of a plurality of computing platforms;
select a first function flavor to implement the requested function;
cause execution of the first function flavor by a first computing hardware component for the requested function;
determine whether performance degradation of the first computing hardware component exists for the first function flavor; and
when performance degradation of the first computing hardware component exists for the first function flavor, select a second function flavor to implement the requested function, and cause execution of the second function flavor by a second computing hardware component for the requested function.

2. The FaaS computing system of claim 1, comprising the memory having instructions stored thereon that, in response to execution by at least one of the plurality of processing cores, cause the processing core to:
when performance degradation of the first computing hardware component does not exist for the first function flavor, continue to cause execution of the first function flavor for requests for the function.

3. The FAAS computing system of claim 1, comprising the memory having instructions stored thereon that, in response to execution by the processing core, cause the processing core to:
determine whether performance degradation of the second computing hardware component exists for the second function flavor and does not exist for the first function flavor; and
when performance degradation of the second computing hardware component exists for the second function flavor and does not exist for the first function flavor, cause execution of the first function flavor by the first computing hardware component for requests for the function.

4. The FAAS computing system of claim 3, comprising the memory having instructions stored thereon that, in response to execution by the processing core, cause the processing core to:
when performance degradation of the second computing hardware component does not exist for the second function flavor, continue to cause execution of the second function flavor for requests for the function.

5. The FAAS computing system of claim 1, the memory having instructions stored thereon that, in response to execution by the processing core, cause the processing core to:
discover available function flavors prior to selecting the first function flavor and the second function flavor.

6. The FAAS computing system of claim 1, the memory having instructions stored thereon that, in response to execution by the processing core, cause the processing core to:
select the first function flavor and the second function flavor using one or more of a service level agreement (SLA) network latency requirement and a computational cost requirement of the requested function.

7. The FAAS computing system of claim 1, the memory having instructions stored thereon that, in response to execution by the processing core, cause the processing core to:
determine whether performance degradation of the first computing hardware component and the second computing hardware component exists using one or more of a service level agreement (SLA) network latency requirement and a computational cost requirement of the requested function.

8. The FAAS computing system of claim 1, the memory having instructions stored thereon that, in response to execution by the processing core, cause the processing core to:
determine whether performance degradation of the first computing hardware component exists using current operating performance measurements of the first computing hardware component, and
determine whether performance degradation of the second computing hardware component exists using current operating performance measurements of the second computing hardware component.

9. The FAAS computing system of claim 1, wherein the first computing hardware component comprises one of a general purpose computing system, a field programmable field array (FPGA), and an application specific integrated circuit (ASIC), and the second computing hardware component comprises one of a general purpose computing system, an FPGA, and an ASIC.

10. A method to be performed by a function as a service (FAAS) computing system, comprising:
receiving a request to perform a function from an application;
discovering one or more flavors for the function, each flavor to implement the function on a selected one of a plurality of computing hardware components of a selected one of a plurality of computing platforms;
selecting a first function flavor to implement the requested function;
causing execution of the first function flavor by a first computing hardware component for the requested function;
determining whether performance degradation of the first computing hardware component exists for the first function flavor; and
when performance degradation of the first computing hardware component exists for the first function flavor, selecting a second function flavor to implement the requested function, and causing execution of the second function flavor by a second computing hardware component for the requested function.

11. The method of claim 10, comprising:
when performance degradation of the first computing hardware component does not exist for the first function flavor, continuing to cause execution of the first function flavor for requests for the function.

12. The method of claim 10, comprising:
determining whether performance degradation of the second computing hardware component exists for the second function flavor and does not exist for the first function flavor; and
when performance degradation of the second computing hardware component exists for the second function flavor and does not exist for the first function flavor, causing execution of the first function flavor by the first computing hardware component for requests for the function.

13. The method of claim 11, comprising:
when performance degradation of the second computing hardware component does not exist for the second function flavor, continuing to cause execution of the second function flavor for requests for the function.

14. The method of claim 10, comprising:
discovering available function flavors prior to selecting the first function flavor and the second function flavor.

15. The method of claim 10, comprising:
selecting the first function flavor and the second function flavor using one or more of a service level agreement (SLA) network latency requirement and a computational cost requirement of the requested function.

16. The method of claim 10, comprising:
determining whether performance degradation of the first computing hardware component and the second computing hardware component exists using one or more of a service level agreement (SLA) network latency requirement and a computational cost requirement of the requested function.

17. The memory of claim 10, comprising:
determining whether performance degradation of the first computing hardware component exists using current operating performance measurements of the first computing hardware component, and
determining whether performance degradation of the second computing hardware component exists using current operating performance measurements of the second computing hardware component.

18. The method of claim 10, wherein the first computing hardware component comprises one of a general purpose computing system, a field programmable field array (FPGA), and an application specific integrated circuit (ASIC), and the second computing hardware component comprises one of a general purpose computing system, an FPGA, and an ASIC.

19. At least one tangible machine-readable medium comprising a plurality of instructions that in response to being executed by a processor cause the processor to:
receive a request to perform a function from an application;
discover one or more flavors for the function, each flavor to implement the function on a selected one of a plurality of computing hardware components of a selected one of a plurality of computing platforms;
select a first function flavor to implement the requested function;
cause execution of the first function flavor by a first computing hardware component for the requested function;
determine whether performance degradation of the first computing hardware component exists for the first function flavor; and
when performance degradation of the first computing hardware component exists for the first function flavor, select a second function flavor to implement the requested function, and cause execution of the second function flavor by a second computing hardware component for the requested function.

20. The at least one tangible machine-readable medium of claim 19, comprising a plurality of instructions that in response to being executed by a processor cause the processor to:
when performance degradation of the first computing hardware component does not exist for the first function flavor, continue to cause execution of the first function flavor for requests for the function.

21. The at least one tangible machine-readable medium of claim 19, comprising a plurality of instructions that in response to being executed by a processor cause the processor to:
determine whether performance degradation of the second computing hardware component exists for the second function flavor and does not exist for the first function flavor; and
when performance degradation of the second computing hardware component exists for the second function flavor and does not exist for the first function flavor, cause execution of the first function flavor by the first computing hardware component for requests for the function.

22. The at least one tangible machine-readable medium of claim 19, comprising a plurality of instructions that in response to being executed by a processor cause the processor to:
when performance degradation of the second computing hardware component does not exist for the second function flavor, continue to cause execution of the second function flavor for requests for the function.

23. The at least one tangible machine-readable medium of claim 19, comprising a plurality of instructions that in response to being executed by a processor cause the processor to:
discover available function flavors prior to selecting the first function flavor and the second function flavor.

24. The at least one tangible machine-readable medium of claim 19, comprising a plurality of instructions that in response to being executed by a processor cause the processor to:
select the first function flavor and the second function flavor using one or more of a service level agreement (SLA) network latency requirement and a computational cost requirement of the requested function.

25. The at least one tangible machine-readable medium of claim 19, comprising a plurality of instructions that in response to being executed by a processor cause the processor to:
determine whether performance degradation of the first computing hardware component and the second computing hardware component exists using one or more of a service level agreement (SLA) network latency requirement and a computational cost requirement of the requested function.

26. The at least one tangible machine-readable medium of claim 19, comprising a plurality of instructions that in response to being executed by a processor cause the processor to:
determine whether performance degradation of the first computing hardware component exists using current operating performance measurements of the first computing hardware component, and
determine whether performance degradation of the second computing hardware component exists using current operating performance measurements of the second computing hardware component.
